(19) United States
(12) Patent Application Publication
(10) Pub. No.: US 2026/0127542 A1
(43) Pub. Date: May 7, 2026

(54) Hardware Asset Management in a Fulfillment Center

(71) Applicant: T-Mobile Innovations LLC, Overland Park, KS (US)

(72) Inventors: Jonathon A. BURR, Leawood, KS (US); Marcus D. FLY, Prosper, TX (US)

(21) Appl. No.: 18/935,295

(22) Filed: Nov. 1, 2024

(51) Int. Cl. G06Q 10/087; H04W 4/35

(52) U.S. Cl. CPC G06Q 10/087; H04W 4/35

(57) ABSTRACT

An inventory management system for a fulfillment center that supports rapid scanning of inventory items using a handheld electronic device. The system comprises a processor, a non-transitory memory storing a plurality of inventory transaction tables, a data verification table, and a committed transaction table, an inventory application stored in the non-transitory memory that, when executed by the processor receives a plurality of scanned code inputs from a mobile application executing on a handheld scanner, writes each received scanned code input into an inventory transaction table, processes each received inventory transaction table, writes processed asset transactions to the data verification table, and in response to receiving a command to commit processed asset transactions, committing processed asset transactions to the committed transaction table.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Fulfillment centers may be depots for different kinds of hardware that will be staged for later delivery to end users. One kind of fulfillment center may be a depot for different kinds of laptop computers and other electronic equipment. Hardware received at the fulfillment center may be in a raw or unconfigured state and may be configured while stored in the fulfillment center. Once configured, the hardware may be shipped out to different end users. Keeping track of both the hardware inventory and the configuration states of the hardware inventory is a complex and dynamic challenge.

### SUMMARY

In an embodiment, an inventory management system for a fulfillment center that supports rapid scanning of inventory items using a handheld electronic device is disclosed. The system comprises a handheld scanner and an inventory management service. The handheld scanner comprises a first processor, a first non-transitory memory, a radio transceiver, a reader, a user interface, and a mobile application stored in the first non-transitory memory. When executed by the first processor, the mobile application receives a selection of an inventory transaction from the user interface, receives a plurality of scanned code inputs from the reader, and transmits the scanned code inputs via the radio transceiver to an inventory management system. The inventory management service comprises a second processor, a second non-transitory memory, and an inventory application stored in the second non-transitory memory. When executed by the second processor, the inventory application receives the scanned code inputs from the mobile application, writes each received scanned code input into an inventory transaction table stored in the second non-transitory memory, processes each received inventory transaction table, writes processed inventory transactions to a data verification table stored in the second non-transitory memory, and, in response to receiving a command to commit processed inventory transactions, committing processed inventory transactions to a committed transactions table stored in the second non-transitory memory.

In another embodiment, a method of inventory management for a fulfillment center that supports rapid scanning of inventory items using a handheld electronic device is disclosed. The method comprises receiving selection of an inventory transaction by a mobile application executing on a handheld scanner; scanning by the handheld scanner a plurality of inventory items; and transmitting information associated with the plurality of inventory items with the identity of the selected transaction operation by the handheld scanner to an inventory transaction table associated with the selected inventory transaction in a data store. The method further comprises processing the information associated with the plurality of inventory items stored in the inventory transaction table based on the identity of the selected inventory transaction by an inventory application executing on a computer system; storing the processed information in a data verification table in the data store by the inventory application; presenting the processed information in a reviewing screen by the inventory application; receiving a commit command associated with the processed information by the inventory application from the viewing screen; and storing the processed information in a committed transaction table by the inventory application.

In yet another embodiment, an inventory management system for a fulfillment center that supports rapid scanning of inventory items using a handheld electronic device is disclosed. The system comprises a processor, a non-transitory memory storing a plurality of inventory transaction tables, a data verification table, and a committed transaction table, and an inventory application stored in the non-transitory memory. When executed by the processor, the inventory application receives a plurality of scanned code inputs from a mobile application executing on a handheld scanner, writes each received scanned code input into an inventory transaction table, processes each received inventory transaction table, writes processed inventory transactions to the data verification table, and, in response to receiving a command to commit processed asset transactions, committing processed asset transactions to the committed transaction table.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of an inventory management system according to an embodiment of the disclosure.

FIG. 2 is a block diagram of an inventory data store according to an embodiment of the disclosure.

FIG. 3 is a flow chart of a method according to an embodiment of the disclosure.

FIG. 4 is an illustration of a handheld mobile device according to an embodiment of the disclosure.

FIG. 5 is a block diagram of a hardware architecture of a handheld mobile device according to an embodiment of the disclosure.

FIG. 6A is a block diagram of a software architecture of a handheld mobile device according to an embodiment of the disclosure.

FIG. 6B is a block diagram of another software architecture of a handheld mobile device according to an embodiment of the disclosure.

FIG. 7 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

An asset inventory system and method are taught herein. In an embodiment, a plurality of user interface screens are embedded in a mobile application, and the mobile application is installed on a mobile electronic device with a scanning capability. For example, the mobile application and embedded interface screens may be installed on a Zebra scanner electronic device. Each different user interface screen may be used to conduct a particular inventory transaction, for example a receive inventory transaction, a transfer inventory transaction, a move inventory transaction, a ship inventory transaction, an add/remove parts inventory transaction, an audit inventory transaction, or a log inventory transaction.

In an embodiment, the particular user interface screen may begin an inventory transaction by capturing meta information about the inventory transaction, for example capturing information from a scanned tag of a pallet on which inventory items are located that identifies the pallet, a current location of the pallet, and a date-time. This meta information can be stored in a first staging table stored in a data store. For example, the mobile application executing on the mobile electronic device may transmit the meta data wirelessly to an access point (AP) located in a fulfillment center, the AP may transmit the meta data to a network, and the network may transmit the meta data to the first staging table stored in a data store communicatively coupled to the network. As individual inventory items are scanned, the scanner can transmit information about the scanned inventory item to be stored as a line entry in the first staging table. Thus, the first staging table comprises the meta information and a plurality of line entries – a single line entry for each different scanned inventory item.

On the completion of the inventory transaction (e.g., after a user clicks a complete transaction button on the particular user interface screen), the first staging table can be copied to a verification table in the data store. In an embodiment, the copying of the first staging table can be performed by an application executing on a computer system. In the process of copying, the content of the first staging table may be processed to form an inventory transaction object, and the inventory transaction object can be stored as one entry among many entries in the verification table. It is noted that the verification table can be considered to be a second staging table. Storing information in the first staging table and copying information from the first staging table to the verification table may be referred to as preserving in-flight inventory transactions or preserving information about in-flight inventory transactions.

A worker can use a work station (e.g., a laptop connected to the network and therethrough to the data store) to review the contents of the inventory transaction just completed and stored in the verification table. If the contents are correct, the user can commit the given inventory transaction. Upon commitment, the inventory transaction information stored in the subject inventory transaction object can be transformed into a long-term data storage that may be visible to other systems within an enterprise domain. This transformation to a long-term data storage may be more convoluted and processing intensive, as various business logic operations may need to be completed pursuant to this transformation. At this point, the first staging table can be deleted and the inventory transaction object associated with this transaction can be removed from the verification table. It is in this way that the first staging table and the verification table can be considered to be “staging tables” – they store data transiently whose ultimate destination is a long-term data storage elsewhere.

In the past, an inventory management system did not use the first staging table and did not use the verification table. Additionally, the earlier inventory management system did not provide the integration of multiple inventory transactions in a unified user interface and instead involved workers performing “swivel seat” operations, wherein the worker used multiple separate tools to perform different inventory transactions using a handheld electronic device. In this “swivel seat” approach, the process of scanning inventory items took about 3 seconds per asset. When scanning a typical number of 500 inventory items stored on a single pallet in a fulfillment center, this amounts to 2+ hours to scan in the inventory items on a single pallet, an unacceptably slow process. Additionally, accumulating the scans by the handheld electronic device until all the scans associated with a transaction were completed and then transmitting them to the long-term data store could sometimes be interrupted and data lost (e.g., because intermediate transaction information is not stored off of the handheld electronic device in the first staging table and/or in the verification table as they are in the novel inventory management system taught herein), losing in-flight inventory transactions or losing information about in-flight inventory transactions, entailing the time-consuming process of collecting the data again. Such interruptions could occur if wireless communication from the handheld electronic device was interrupted for some reason in the inventory environment (e.g., fulfillment center or warehouse) or if the handheld electronic device powered off accidentally or because of a depleted on-board battery. The present disclosure teaches a particular technical solution to the technical task of inventory control and management in a large fulfillment center that overcomes these shortcomings of the previous inventory management process. For example, the two staging tables help prevent the loss of scanned data if some communication hiccup occurs, avoiding repeating the scanning process. The use of the two staging tables also speeds the process of scanning information, as the scanning process does not need to wait on the more time-consuming, processor intensive action of transforming the raw data that was scanned into a form suitable for the long-term data storage.

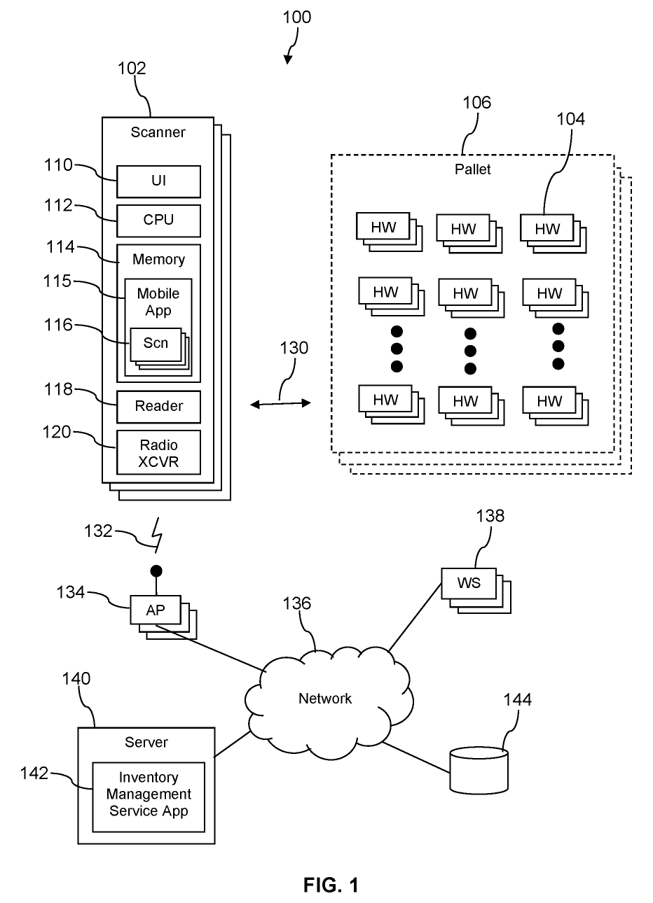

Turning now to FIG. 1, an inventory management system 100 is described. In an embodiment, the system 100 comprises a scanner device 102 that is used to read information from a plurality of assets or inventory items 104. In an embodiment, a plurality of the inventory items 104 may be stored on a same pallet 106. In an embodiment, the inventory items 104 may be laptop computers destined for use by employees of a large enterprise, but it will be appreciated that the system 100 and methods described herein can be applied to managing a wide variety of inventory items and for any scale of enterprise or organization. It will be appreciated that the system 100 may comprise any number of pallets 106, and each pallet 106 may be associated with any number of inventory items 104. For example, the system 100 may comprise hundreds or thousands of pallets 106. For example, each pallet 106 may be associated with tens or hundreds of inventory items 104. While FIG. 1 and the description herein associates inventory items 104 to a pallet 106, it will be appreciated that a plurality of inventory items 104 may be associated not with a pallet 106 but instead may be associated with wooden crates or cardboard boxes or plastic boxes. It is understood that the system 100 may comprise a plurality of scanner devices 102.

The scanner devices 102 may be a mobile communication device. The scanner devices 102 may be handheld mobile communication devices. The scanner devices 102 comprise a user interface 110, a processor (CPU) 112, a non-transitory memory 114, a reader 118, and a radio transceiver 120. The reader 118 may be configured to read bar code labels coupled to the pallets 106 and bar code labels affixed to the inventory items 104. It is understood that bar code labels may comprise universal product codes (UPCs) or two-dimensional bar codes such as semacodes, quick response (QR) codes, circular bar codes, or ShotCodes. Alternatively, the reader 118 may be configured to read radio frequency identity (RFID) tags affixed to the pallets 106 and RFID tags affixed to the inventory items 104. The bar code labels or RFIDs may encode a generic identity and unique serial number. The bar code labels or RFIDs may encode additional information, such as an identity of an original equipment manufacturer (OEM) and/or a manufacturing date. In some contexts, bar code labels may simply be referred to as bar codes. The reading of bar code labels and/or RFID tags is suggested in FIG. 1 by the arrowed line 130.

The non-transitory memory 114 may store a mobile application 115 that, when executed by the processor 112, performs a variety of inventory management and/or auditing functions. The mobile application 115 may provide instructions for executing by the processor 112 and presenting a plurality of inventory transaction screens 116 on the UI 110. In an embodiment, the transaction screens 116 may comprise one or more of a receive inventory transaction screen, a transfer inventory transaction screen, a move inventory transaction screen, a ship inventory transaction screen, an add/remove parts inventory transaction screen, an audit inventory transaction screen, and/or an inbound log inventory transaction screen.

The radio transceiver 120 comprises a radio that can establish a wireless communication link 132 with a wireless access point (AP) 134, for example a WiFi AP or other short-range wireless AP. Alternatively, the radio transceiver 120 can establish a wireless communication link with a cell site according a 5G, long-term evolution (LTE), a code division multiple access (CDMA), or a global system for mobile communication (GSM) telecommunication protocol. The AP 134 (or cell site) provides a link to a network 136. The network 136 comprises one or more private networks, one or more public networks, or a combination thereof. In an embodiment, the system 100 comprises a plurality of APs 134, for example distributed at different points within a fulfillment center.

The system 100 further comprises one or more workstations (WS) 138 and a computer system 140. The computer system 140 comprises an inventory management service application 142. The system 100 further comprises a data store 144 that stores information about the inventory items 104. The scanners 102, the APs 134, the workstations 138, the server 140 and inventory management service application 142, and the data store 144 may be considered to provide an inventory management system and the inventory items 104 and pallets 106 may be considered the inventory that is managed.

When a user selects a transaction screen 116 to interact with on the UI 110, the selected screen 116 is readied to receive inputs and conduct actions. The user can choose to scan a pallet 106 (e.g., scan and capture data associated with a bar code label or RFID tag affixed to the pallet) and perform an inventory transaction. The transaction can associate meta information to the given transaction, where this meta information may comprise a pallet identity, a pallet location, a date-time stamp, and other information. The transaction can associate individual inventory items 104 to a pallet 106. For example, upon receiving a pallet 106 of inventory items 104 into a warehouse or fulfillment center, a user may initiate a receive asset inventory transaction, scan the pallet, scan each of the inventory items 104 (e.g., scan and capture data associated with a bar code label or an RFID tag affixed to each inventory item 104), complete the transaction, and meta data about the pallet 106 is stored along with identifying information of each of the scanned inventory items 104. In an embodiment, once individual inventory items 104 are associated to the pallet 106 (e.g., the association is stored in the data store 144), transactions performed on the pallet 106 are considered to be performed on the individual inventory items 104 associated to the pallet 106.

When the pallet 106 is moved – for example moved from a receiving dock in a warehouse or fulfillment center to a configuration work area – a move transaction can be selected using a screen 116 presented on the UI 110 of the scanner device 102 and information about the changed location of the pallet 106 entered and the move transaction completed. The move transaction and new location associated with the pallet 106 is linked to or associated to the inventory items 104 associated to the pallet 106. At the configuration work area, individual inventory items 104 may be configured, for example different laptop computers may be configured with different images whereby to enable the different laptop computers to fulfill work tasks for employees of a large enterprise who have different work functions and different levels of access to confidential information. In an embodiment, an add/remove parts transaction can be conducted on each inventory item 104 or a plurality of inventory items 104 that have been configured in the same way, and information about the configuration selected with the screen 116 and entered using the UI 110 of the scanner device 102.

Other inventory transactions can be completed using the scanner device 102 – either for the pallet 106 (and hence for each of the inventory items 104 associated with the pallet 106), for a plurality of inventory items 104, or a single inventory item 104. A transfer transaction can transfer ownership and/or responsibility for the inventory item(s) 104. A ship transaction can be completed to track dispatch of inventory items 104 from a warehouse or fulfillment center to end users. An audit transaction can be performed to audit inventory items 104. Audits transactions may be performed for a variety of purposes including, but not limited to, one or more of verifying inventory asset quantities, verifying inventory asset locations, and/or verifying inventory asset states. A log transaction can be performed. As shipments arrive at an inventory location (e.g., in a warehouse or in a fulfillment center), high level information related to the received shipment may be captured in a log including the shipping company, tracking number of the shipment, number of pallets in the shipment, make and model of assets on the pallets. This information may be separate from asset information that is entered post shipment receiving, as the pallets are unpacked. Such inbound shipment logging supports logistics.

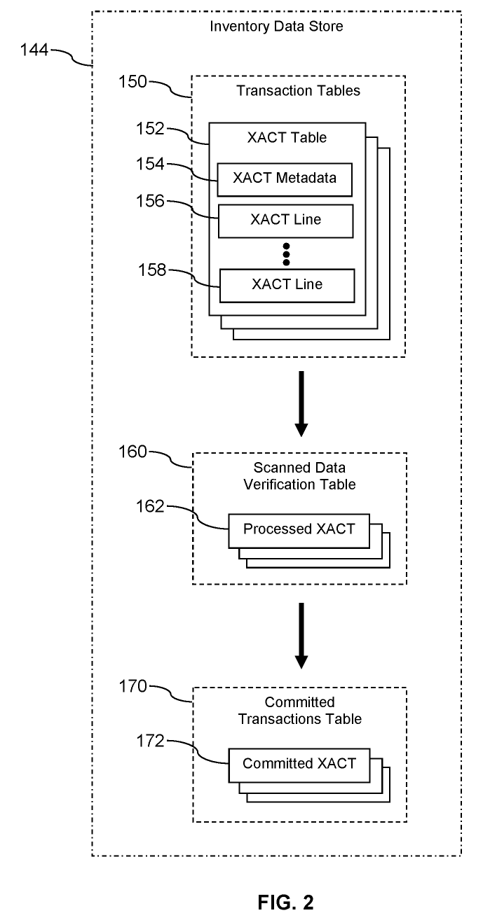

Turning now to FIG. 2, further details of the data store 144 are described. In an embodiment, the data store 144 may comprise a plurality of transactions tables 150 (for example, a first transaction table 152), a scanned data verification table 160, and a committed transactions table 170. Each transaction table 152 comprises transaction metadata 154, and a plurality of transaction lines 156, 158. The transaction metadata 154 may include a variety of information related to the transaction. The transaction metadata 154 may comprise a purchase order (PO) number associated with the transaction, a pallet identity associated with the transaction, a model number of one or more inventory items associated with the pallet.

As a transaction is initiated by the scanner device 102, a transaction table 152 associated with that specific transaction is created by the inventory management service application 142 in the data store 144 and transaction metadata 154 is placed in the transaction table 152. As inventory items 104 are scanned, the inventory management service application 142 creates and adds transaction lines 156, 158 to the transaction table 152. Additionally, the inventory management service application may create and add transaction lines 156, 158 to the transaction table 152 as information related to the given transaction are entered via the UI 110 of the scanner 102, for example information about a version of image being installed into a non-transitory memory of a laptop computer (e.g., an inventory item 104).

It is noted that the progressive building of the transaction table 152 in the data store 144 by the inventory management service application 142 occurs in response to actions taken on the scanner device 102. Thus, the scanner device 102 is transmitting a stream of events and information via the AP 134 and the network 136 to the inventory management service application 142, and the inventory management service application 142 writes into the data store 144 as the given transaction progresses. In this way, if the mobile application 115 crashes or if the wireless link 132 between the radio transceiver 120 and the AP 134 goes down, the already completed portion of the inventory transaction to that point in time (e.g., in-flight transaction information) is not lost and those actions do not need to be repeated, thereby saving time.

When the given inventory transaction is completed, for example when the user of the scanner device 102 clicks a button presented in the screen 116 on the UI 110 indicating the transaction is completed, the inventory management service application 142 processes the associated transaction table 152 and writes the information associated with the transaction metadata 154 and the transaction lines 156, 158 to a processed transaction entry 162 in the scanned data verification table 160.

The worker may then pull-up the processed transaction entry 162 on one of the work stations 138 to review the given processed transaction entry 162. Reviewing the processed transaction entry 162 may involve making sure the different fields of the processed transaction entry 162 make sense and are in the correct form. For example, this may involve assuring that text strings had meaningful text rather than a crazy scramble of letters, numerals, and special characters. For example, this may involve assuring ten-digit identity numbers were all numbers and all ten digits long. When the worker has visually verified the given processed transaction entry 162, the worker can commit the processed transaction entry 162, and the inventory management service application 142 can transform this processed transaction entry 162 into a corresponding committed transaction 172 that is stored in the committed transactions table 170. In an embodiment, the worker may complete a plurality of transactions using the scanner device 102 (e.g., creating a plurality of processed transaction entries 162 in the scanned data verification table 160 and then review and commit the plurality of completed transactions using the work station 138. In an embodiment, rather than workers visually verifying the processed transactions 162, a function of the inventory management service application 142 may automatically examine and commit the processed transactions 162.

The inventory management service application 142 conducts a variety of actions when generating committed transactions 172 based on the processed transactions 162 and storing them in the committed transactions table 170. The processing that creates the committed transactions 172 and stores them in the committed transaction table 170 and completes related ancillary actions can be time consuming and eat up processing time in the server 140. The use of the staging tables (e.g., the transaction tables 150 and the scanned data verification table 160) promote the rapid scanning and inputting of data by workers using the scanner device 102 without having to wait for each scan action to be processed into the backend of the committed transactions table 170, thereby making a more efficient use of worker time. Ancillary actions that are also either completed by the inventory management service application 142 when generating committed transactions 172 may include creating configuration items associated with the committed transactions 170 and/or the inventory items 104 and creating inventory item records for the configuration items. By deferring the commitment of the processed transactions 162 stored in the scanned data verification table 160 until they have been verified by a worker or, alternatively, by an automated function of the inventory management service application 142, the time-consuming activity of unwinding backing out backend data storage errors that otherwise might propagate into long-term data storage. Instead, any errors in the processed transactions 162 may be discovered before being committed and the trouble of unwinding and correcting the error in the backend data storage is avoided, thereby increasing efficiency of the computer-based inventory management system 100.

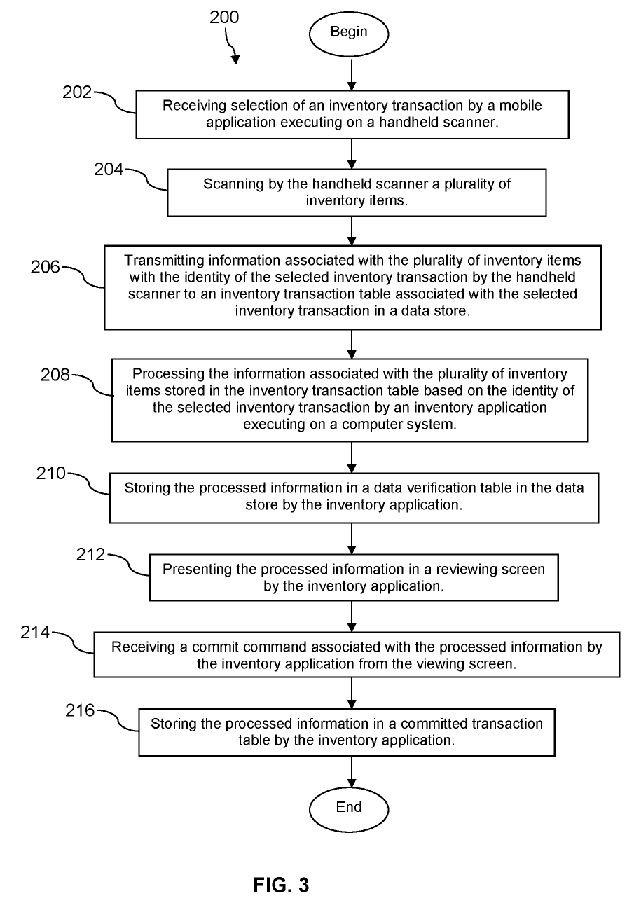

Turning now to FIG. 3, a method 200 is described. In an embodiment, the method 200 is a method of inventory management for a fulfillment center that supports rapid scanning of inventory items using a handheld electronic device. In an embodiment, the inventory items comprise laptop computers. In an embodiment, the inventory items comprise mobile communication device such as mobile phones, smartphones, wearable computers, headset computers, tablet computers, or notebook computers. At block 202, the method 200 comprises receiving selection of an inventory transaction by a mobile application executing on a handheld scanner.

At block 204, the method 200 comprises scanning by the handheld scanner a plurality of inventory items. In an embodiment, scanning the plurality of inventory items by the handheld scanner comprises scanning a plurality of bar code labels affixed to inventory items. In an embodiment, scanning the plurality of inventory items by the handheld scanner comprises scanning a plurality of radio frequency identity (RFID) tags affixed to inventor items. At block 206, the method 200 comprises transmitting information associated with the plurality of inventory items with the identity of the selected inventory transaction by the handheld scanner to an inventory transaction table associated with the selected inventory transaction in a data store. The information associated with the inventory items may comprise two or more of a purchase order number, a pallet identity, an inventory item identity, and a version of an image installed on the inventory items. In an embodiment, the inventory transaction table is a staging table. In an embodiment, the handheld scanner transmits the information via a wireless communication link, for example via a WiFi wireless communication link or by a cellular wireless communication link. When a cellular wireless communication link is used, the cellular wireless communication link may be provided by a cell site to the handheld scanner according to a 5G, a long-term evolution, a code division multiple access (CDMA), or a global system for mobile communication (GSM) telecommunication protocol.

At block 208, the method 200 comprises processing the information associated with the plurality of inventory items stored in the inventory transaction table based on the identity of the selected inventory transaction by an inventory application executing on a computer system. At block 210, the method 200 comprises storing the processed information in a data verification table in the data store by the inventory application. In an embodiment, the data verification table is a staging table.

At block 212, the method 200 comprises presenting the processed information in a reviewing screen by the inventory application. At block 214, the method 200 comprises receiving a commit command associated with the processed information by the inventory application from the viewing screen. At block 216, the method 200 comprises storing the processed information in a committed transaction table by the inventory application.

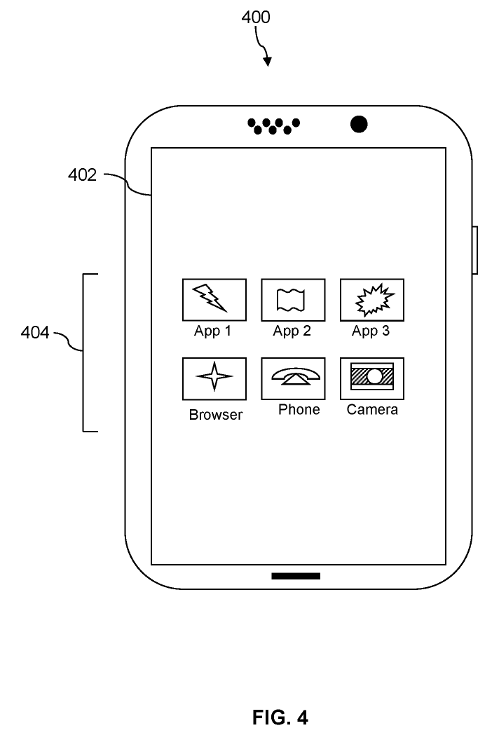

Turning now to FIG. 4, a user equipment (UE) 400 is described0 which is operable for implementing aspects of the present disclosure, but the present disclosure should not be limited to these implementations. For example, the scanner device 102 described above with reference to FIG. 1 may be implemented in a configuration similar to that illustrated in FIG. 4. Though illustrated as a mobile phone, the UE 400 may take various forms including a wireless handset, a pager, a personal digital assistant (PDA), a gaming device, or a media player. The UE 400 includes a touchscreen display 402 having a touch-sensitive surface for input by a user. A small number of application icons 404 are illustrated within the touch screen display 402. It is understood that in different embodiments, any number of application icons 404 may be presented in the touch screen display 402. In some embodiments of the UE 400, a user may be able to download and install additional applications on the UE 400, and an icon associated with such downloaded and installed applications may be added to the touch screen display 402 or to an alternative screen. The UE 400 may have other components such as electro-mechanical switches, speakers, camera lenses, microphones, input and/or output connectors, and other components as are well known in the art. The UE 400 may present options for the user to select, controls for the user to actuate, and/or cursors or other indicators for the user to direct. The UE 400 may further accept data entry from the user, including numbers to dial or various parameter values for configuring the operation of the handset. The UE 400 may further execute one or more software or firmware applications in response to user commands. These applications may configure the UE 400 to perform various customized functions in response to user interaction. Additionally, the UE 400 may be programmed and/or configured over-the-air, for example from a wireless base station, a wireless access point, or a peer UE 400. The UE 400 may execute a web browser application which enables the touch screen display 402 to show a web page. The web page may be obtained via wireless communications with a base transceiver station, a wireless network access node, a peer UE 400 or any other wireless communication network or system.

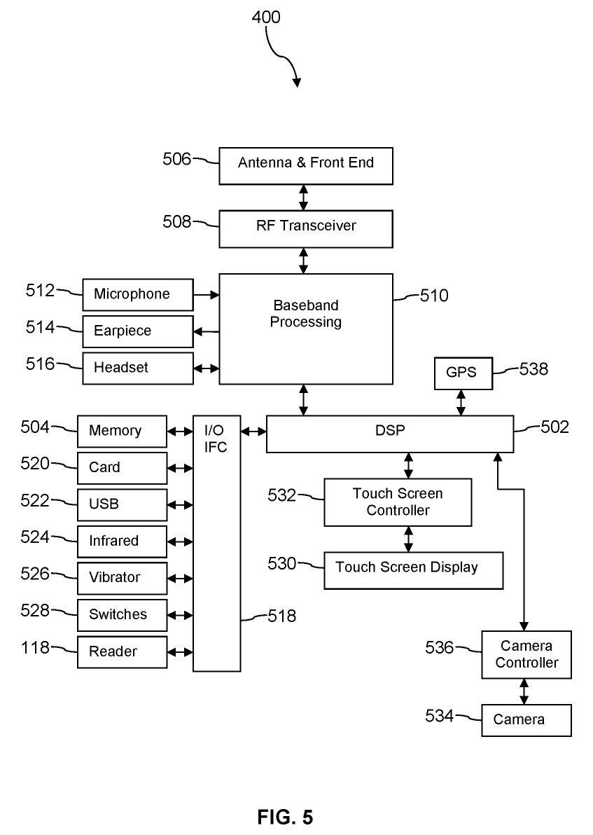

FIG. 5 shows a block diagram of the UE 400. While a variety of known components of handsets are depicted, in an embodiment a subset of the listed components and/or additional components not listed may be included in the UE 400. The UE 400 includes a digital signal processor (DSP) 502 and a memory 504. As shown, the UE 400 may further include one or more antenna and front end unit 506, a one or more radio frequency (RF) transceiver 508, a baseband processing unit 510, a microphone 512, an earpiece speaker 514, a headset port 516, an input/output interface 518, a removable memory card 520, a universal serial bus (USB) port 522, an infrared port 524, a vibrator 526, one or more electro-mechanical switches 528, a touch screen display 530, a touch screen controller 532, a camera 534, a camera controller 536, and a global positioning system (GPS) receiver 538. In an embodiment, the UE 400 may include another kind of display that does not provide a touch sensitive screen. In an embodiment, the UE 400 may include both the touch screen display 530 and additional display component that does not provide a touch sensitive screen. In an embodiment, the DSP 502 may communicate directly with the memory 504 without passing through the input/output interface 518. Additionally, in an embodiment, the UE 400 may comprise other peripheral devices that provide other functionality.

The DSP 502 or some other form of controller or central processing unit operates to control the various components of the UE 400 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The DSP 502 may communicate with a wireless network via the analog baseband processing unit 510. In some embodiments, the communication may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB port 522 and the infrared port 524. The USB port 522 may enable the UE 400 to function as a peripheral device to exchange information with a personal computer or other computer system. The infrared port 524 and other optional ports such as a Bluetooth® interface or an IEEE 802.11 compliant wireless interface may enable the UE 400 to communicate wirelessly with other nearby handsets and/or wireless base stations.

In an embodiment, one or more of the radio transceivers is a cellular radio transceiver. A cellular radio transceiver promotes establishing a wireless communication link with a cell site according to one or more of a 5G, a long-term evolution (LTE), a code division multiple access (CDMA), a global system for mobile communications (GSM) wireless communication protocol. In an embodiment, one of the radio transceivers 508 may comprise a near field communication (NFC) transceiver. The NFC transceiver may be used to complete payment transactions with point-of-sale terminals or other communications exchanges. In an embodiment, each of the different radio transceivers 508 may be coupled to its own separate antenna. In an embodiment, the UE 400 may comprise a radio frequency identify (RFID) reader and/or writer device.

The switches 528 may couple to the DSP 502 via the input/output interface 518 to provide one mechanism for the user to provide input to the UE 400. Alternatively, one or more of the switches 528 may be coupled to a motherboard of the UE 400 and/or to components of the UE 400 via a different path (e.g., not via the input/output interface 518), for example coupled to a power control circuit (power button) of the UE 400. The touch screen display 530 is another input mechanism, which further displays text and/or graphics to the user. The touch screen LCD controller 532 couples the DSP 502 to the touch screen display 530. The GPS receiver 538 is coupled to the DSP 502 to decode global positioning system signals, thereby enabling the UE 400 to determine its position.

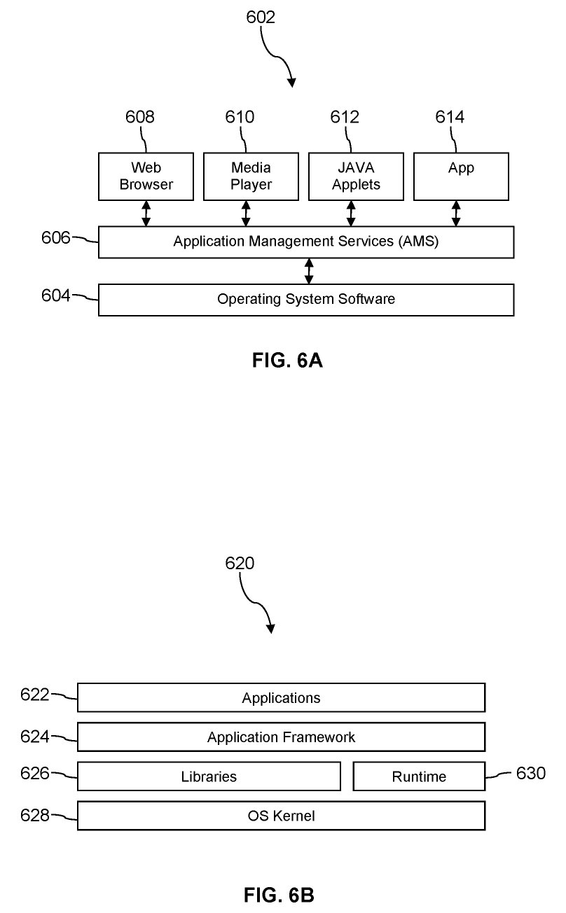

FIG. 6A illustrates a software environment 602 that may be implemented by the DSP 502. The DSP 502 executes operating system software 604 that provides a platform from which the rest of the software operates. The operating system software 604 may provide a variety of drivers for the handset hardware with standardized interfaces that are accessible to application software. The operating system software 604 may be coupled to and interact with application management services (AMS) 606 that transfer control between applications running on the UE 400. Also shown in FIG. 6A are a web browser application 608, a media player application 610, and JAVA applets 612. The web browser application 608 may be executed by the UE 400 to browse content and/or the Internet, for example when the UE 400 is coupled to a network via a wireless link. The web browser application 608 may permit a user to enter information into forms and select links to retrieve and view web pages. The media player application 610 may be executed by the UE 400 to play audio or audiovisual media. The JAVA applets 612 may be executed by the UE 400 to provide a variety of functionality including games, utilities, and other functionality.

FIG. 6B illustrates an alternative software environment 620 that may be implemented by the DSP 502. The DSP 502 executes operating system kernel (OS kernel) 628 and an execution runtime 630. The DSP 502 executes applications 622 that may execute in the execution runtime 630 and may rely upon services provided by the application framework 624. Applications 622 and the application framework 624 may rely upon functionality provided via the libraries 626.

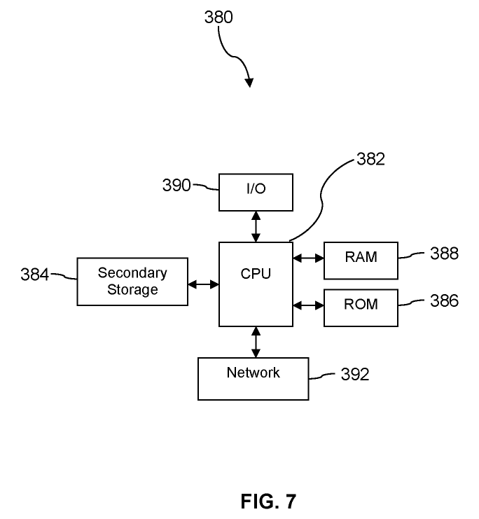

FIG. 7 illustrates a computer system 380 suitable for implementing one or more embodiments disclosed herein. For example, the server 140 and the workstations 138 may be implemented in a form similar to the computer system 380 illustrated in FIG. 7. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. An inventory management system for a fulfillment center that supports rapid scanning of inventory items using a handheld scanner and that supports preserving in-flight inventory transactions, comprising:
a handheld scanner comprising:
a first processor,
a first non-transitory memory,
a radio transceiver,
a reader,
a user interface, and
a mobile application stored in the first non-transitory memory that, when executed by the first processor:
receives a selection of an inventory transaction from the user interface,
receives a plurality of scanned code inputs from the reader, and
transmits the scanned code inputs via the radio transceiver to an inventory management system; and
an inventory management service comprising:
a second processor,
a second non-transitory memory,
an inventory application stored in the second non-transitory memory that, when executed by the second processor:
receives the scanned code inputs from the mobile application,
writes each received scanned code input into an inventory transaction table stored in the second non-transitory memory,
processes each received inventory transaction table,
writes processed inventory transactions to a data verification table stored in the second non-transitory memory, and
in response to receiving a command to commit processed inventory transactions, commits processed inventory transactions to a committed transactions table stored in the second non-transitory memory.

2. The inventory management system of claim 1, wherein the radio transceiver is configured to provide a WiFi wireless communication link to a wireless access point (AP).

3. The inventory management system of claim 1, wherein the radio transceiver is configured to provide a cellular radio communication link to a cell site.

4. The inventory management system of claim 1, wherein the mobile application is configured to provide a plurality of screens, wherein each different screen supports completing a different inventory transaction.

5. The inventory management system of claim 4, wherein the different inventory transactions comprise a receive inventory transaction, a transfer inventory transaction, a move inventory transaction, a ship inventory transaction, an add/remove parts inventory transaction, an audit inventory transaction, and a log inventory transaction.

6. The inventory management system of claim 1, wherein the reader is configured to read a bar code.

7. The inventory management system of claim 1, wherein the reader is configured to read a radio frequency identity (RFID) tag.

8. A method of inventory management for a fulfillment center that supports rapid scanning of inventory items using a handheld electronic device and that supports preserving in-flight inventory transactions, comprising:
receiving selection of an inventory transaction by a mobile application executing on a handheld scanner;
scanning by the handheld scanner a plurality of inventory items;
transmitting information associated with the plurality of inventory items with the identity of the selected inventory transaction by the handheld scanner to an inventory transaction table associated with the selected inventory transaction in a data store;
processing the information associated with the plurality of inventory items stored in the inventory transaction table based on the identity of the selected inventory transaction by an inventory application executing on a computer system;
storing the processed information in a data verification table in the data store by the inventory application;
presenting the processed information in a reviewing screen by the inventory application;
receiving a commit command associated with the processed information by the inventory application from the viewing screen; and
storing the processed information in a committed transaction table by the inventory application.

9. The method of claim 8, wherein the inventory transaction table is a staging table and the data verification table is a staging table.

10. The method of claim 8, wherein scanning the plurality of inventory items by the handheld scanner comprises scanning a plurality of bar code labels affixed to inventory items.

11. The method of claim 8, wherein scanning the plurality of inventory items by the handheld scanner comprises scanning a plurality of radio frequency identity (RFID) tags affixed to inventor items.

12. The method of claim 8, wherein transmitting by the handheld scanner comprises transmitting via a wireless link by the handheld scanner.

13. The method of claim 8, wherein the plurality of inventory items comprises laptop computers.

14. The method of claim 13, wherein information associated with the plurality of inventory items comprises two or more of a purchase order number, a pallet identity, an inventory item identity, and a version of an image installed on the laptop.

15. An inventory management system for a fulfillment center that supports rapid scanning of inventory items using a handheld electronic device, comprising:
a processor;
a non-transitory memory storing a plurality of inventory transaction tables, a data verification table, and a committed transaction table; and
an inventory application stored in the non-transitory memory that, when executed by the processor
receives a plurality of scanned code inputs from a mobile application executing on a handheld scanner,
writes each received scanned code input into an inventory transaction table,
processes each received inventory transaction table,
writes processed inventory transactions to the data verification table, and
in response to receiving a command to commit processed asset transactions, committing processed inventory transactions to the committed transaction table.

16. The inventory management system of claim 15, wherein the inventory items are laptop computers.

17. The inventory management system of claim 15, wherein the inventory transaction table and the data verification table are staging tables.

18. The inventory management system of claim 15, wherein the plurality of scanned code inputs received from the mobile application by the inventory application comprise a purchase order number and a pallet number.

19. The inventory management system of claim 18, wherein the plurality of scanned code inputs received from the mobile application by the inventory application comprises information about a version of image being installed.

20. The inventory management system of claim 15, wherein committing processed inventory transactions comprises creating inventory item records in a backend data store.
